(19) United States
(12) Patent Application Publication
(10) Pub. No.: US 2017/0140385 A1
(43) Pub. Date: May 18, 2017

(54) METHOD AND SYSTEM FOR SECONDARY PROCESSING OF TRANSACTIONS

(71) Applicant: MasterCard International Incorporated, Purchase, NY (US)

(72) Inventors: Brian DOBSON, Wilton, CT (US); Jose A. ALBA, Long Island City, NY (US); Venu APPANA, Lexington, MA (US)

(73) Assignee: MasterCard International Incorporated, Purchase, NY (US)

(21) Appl. No.: 14/940,630

(22) Filed: Nov. 13, 2015

(51) Int. Cl. G06Q 20/40

(52) U.S. Cl. CPC G06Q 20/4016; G06Q 20/405

(57) ABSTRACT

A method for processing a declined payment transaction using a secondary financial institution includes: receiving a transaction message for a payment transaction from an acquiring institution, the transaction message including a primary account number, transaction amount, institution identifier, and transaction data; calculating a fraud score based on application of fraud algorithms to data included in the transaction message; transmitting the transaction message and fraud score to an issuer; receiving an authorization response from the issuer, the response including a response code indicative of denial of the transaction; identifying a secondary financial institution; modifying the transaction message by replacing the institution identifier with an alternative identifier associated with the secondary financial institution; and transmitting the modified transaction message to the acquiring institution.

### FIELD

The present disclosure relates to the secondary processing of electronic payment transactions, particularly cross border transactions, and more specifically the processing of a declined electronic payment transaction using a secondary financial institution or other entity.

### BACKGROUND

Issuers and other financial institutions that are associated with transaction accounts will often evaluate details for a payment transaction to determine if the transaction should be approved or denied. Evaluation of the details can be performed to determine if the transaction account has a sufficient balance or credit for the transaction, if use of the transaction account is authorized and/or authenticated, or if the transaction may be fraudulent. Financial institutions often place a lot of importance on fraud determinations, as fraudulent transactions can result in a significant loss of revenue.

However, financial institutions may sometimes decline a payment transaction due to concerns of fraud, even in instances where the transaction may be genuine. Furthermore, some financial institutions may decline all payment transactions that have certain criteria in order to prevent fraud, such as declining all cross border transactions involving a specific country. While this may help prevent fraud for the financial institution, it may also adversely affect individuals whose transaction accounts cannot be used in instances where genuine transactions will be declined due to the criteria, even in instances where the transaction may have a low fraud risk.

Thus, there is a need for a technical solution to provide for the processing of a payment transaction even in instances where the transaction is denied by the account's issuing financial institution due to fraud concerns. The use of an automatic way a secondary financial institution may accept the risk of fraud for the transaction may enable genuine transactions that would otherwise be declined be successfully processed. As such, a technical improvement comprising modification of a transaction processing system to accommodate a secondary financial institution in such instances may provide a suitable technical solution in such instances.

### SUMMARY

The present disclosure provides a description of systems and methods for processing a declined payment transaction using a secondary financial institution.

A method for processing a declined payment transaction using a secondary financial institution includes: storing, in a memory of a processing server, one or more algorithms configured to generate a fraud score for a transaction; receiving, by a receiving device of the processing server, a transaction message for a payment transaction from an acquiring institution, wherein the transaction message is formatted pursuant to one or more standards and includes a plurality of data elements including at least a first data element configured to store a primary account number associated with a transaction account, a second data element configured to store a transaction amount, a third data element configured to store an institution identifier associated with a primary financial institution related to the transaction account associated with the primary account number, and one or more additional data elements configured to store transaction data; calculating, by a processing device of the processing server, a fraud score for the payment transaction based on application of the one or more algorithms stored in the memory of the processing server to at least the transaction amount stored in the second data element of the received transaction message and the transaction data stored in the one or more additional data elements of the received transaction message; electronically transmitting, by a transmitting device of the processing server, the received transaction message and the calculated fraud score to the primary financial institution; receiving, by the receiving device of the processing server, an authorization response from the primary financial institution, wherein the authorization response includes a data element configured to store a response code indicative of denial of the payment transaction; identifying, by the processing device of the processing server, a secondary financial institution; modifying, by the processing device of the processing server, the received transaction message by replacing the institution identifier stored in the second data element of the received transaction message with an alternative identifier associated with the identified secondary financial institution; and electronically transmitting, by the transmitting device of the processing server, the modified transaction message to the acquiring institution.

A system for processing a declined payment transaction using a secondary financial institution includes a memory, a receiving device, a processing device, and a transmitting device of a processing server. The memory of the processing server is configured to store one or more algorithms configured to generate a fraud score for a transaction. The receiving device of the processing server is configured to receive a transaction message for a payment transaction from an acquiring institution, wherein the transaction message is formatted pursuant to one or more standards and includes a plurality of data elements including at least a first data element configured to store a primary account number associated with a transaction account, a second data element configured to store a transaction amount, a third data element configured to store an institution identifier associated with a primary financial institution related to the transaction account associated with the primary account number, and one or more additional data elements configured to store transaction data. The processing device of the processing server is configured to calculate a fraud score for the payment transaction based on application of the one or more algorithms stored in the memory of the processing server to at least the transaction amount stored in the second data element of the received transaction message and the transaction data stored in the one or more additional data elements of the received transaction message. The transmitting device of the processing server is configured to electronically transmit the received transaction message and the calculated fraud score to the primary financial institution. The receiving device of the processing server is further configured to receive an authorization response from the primary financial institution, wherein the authorization response includes a data element configured to store a response code indicative of denial of the payment transaction. The processing device of the processing server is further configured to identify a secondary financial institution, and modify the received transaction message by replacing the institution identifier stored in the second data element of the received transaction message with an alternative identifier associated with the identified secondary financial institution. The transmitting device of the processing server is further configured to electronically transmit the modified transaction message to the acquiring institution.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for secondary processing of declined payment transactions in accordance with exemplary embodiments.

FIG. 2 is a block diagram illustrating the processing server of FIG. 1 for processing declined payment transactions using secondary financial institutions in accordance with exemplary embodiments.

FIGS. 3-5 are flow diagrams illustrating processes for secondary processing of declined payment transactions using the system of FIG. 1 in accordance with exemplary embodiments.

FIG. 6 is a flow chart illustrating an exemplary method for processing a declined payment transaction using a secondary financial institution in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal , etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Primary Account Number—A data string used to identify with a transaction account held by a consumer at a financial institution, which may be sent by a merchant at least as part of a transaction authorization request. It may be a real payment account number (PAN) (e.g., the number on a regular credit or debit card), tokens or virtual account numbers (VCNs) which replace a PAN for a given transaction, a given merchant or used in conjunction with a mobile device particularly where near field communication (NFC) is used as part of a transaction at a point of sale (POS), or other data representing or associated with a PAN.

### System for Secondary Processing of Declined Payment Transactions

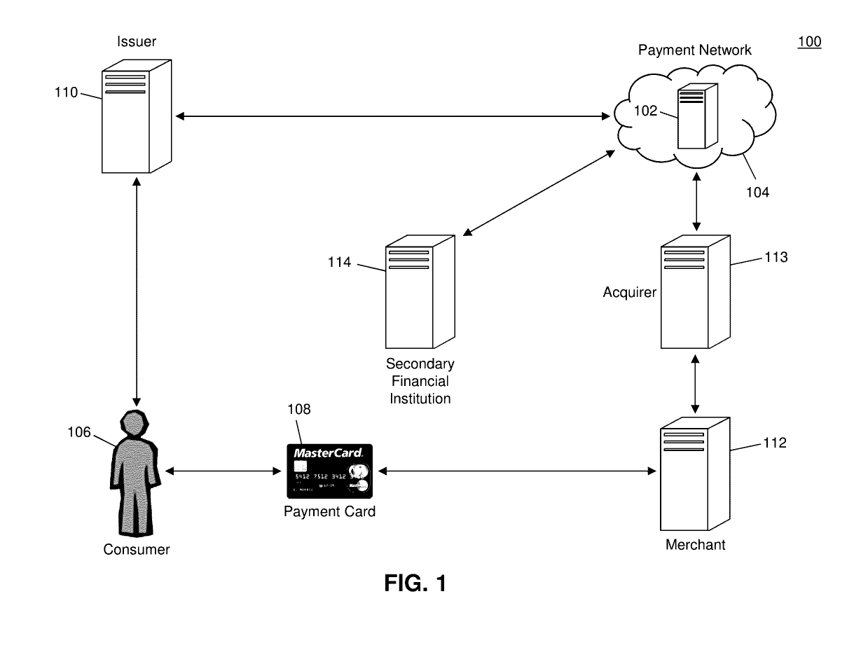

FIG. 1 illustrates a system 100 for the secondary processing of declined payment transactions using an alternative financial institution for acceptance of risk of the payment transaction.

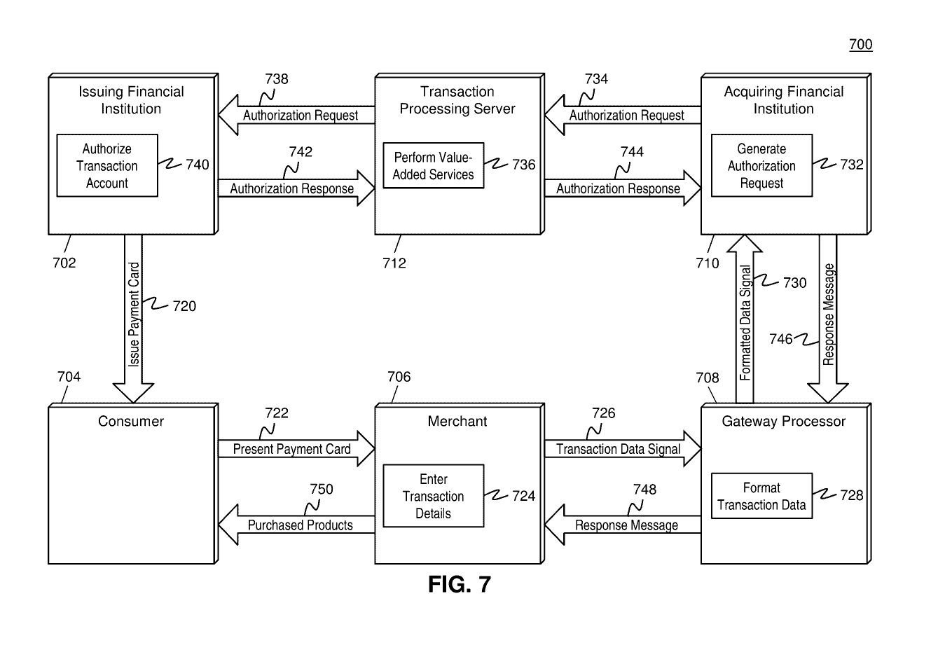

The system 100 may include a processing server 102. The processing server 102, discussed in more detail below, may be configured to process payment transactions, including the use of secondary processing for declined payment transactions. The processing server 102 may be part of a payment network 104 configured to communicate transaction messages via the payment rails, which may be specialized infrastructure of the payment network 104 specially configured and formatted to perform the exchange of transaction messages and processing of payment transactions. The payment rails and exchange of data and transaction messages in the processing of payment transactions is discussed in more detail below with respect to the process 700 illustrated in FIG. 7.

In the system 100, a consumer 106 may initiate a payment transaction. As part of the initiation of the payment transaction, the consumer 106 may present a payment card 108 for use in conveying payment details associated with a transaction account used to fund the payment transaction. The transaction account may be associated with an issuer 110, which may be a financial institution, such as an issuing bank, that owns, manages, or is otherwise associated with the transaction account. The payment card 108 may be a physical card issued to the consumer 106 by the issuer 110 or an authorized entity or may be a virtual card, such as may be stored in an electronic wallet application program on a computing device. The payment card 108 may be encoded with or otherwise provide access to payment details suitable for use in a payment transactions. Payment details may include, for example, an account number, name of the consumer 106, postal code, street address, application cryptogram, etc.

As part of the initiation of the payment transaction, the consumer 106 may present the payment card 108 to a merchant 112. The merchant 112 or a computing system associated thereto, such as a point of sale device or system, may read, decode, or otherwise receive the payment details associated with the payment card 108. For example, if the payment card 108 is a physical card, the merchant 112 may include a reading device configured to read and/or decode payment details encoded in a magnetic stripe or integrated circuit chip of the payment card 108. In another example, if the payment card 108 is a virtual card, the merchant 112 may include a device configured to read payment details from a computing device configured to store the virtual card, such as via the optical scanning of a machine-readable code encoded with payment details, the receipt of payment details transmitted via near field communication, etc. In some instances, the payment transaction initiated by the consumer 106 may be a remote or e-commerce transaction. In such instances, payment details may be conveyed via transmission using a suitable communication network, such as a cellular communication network, radio frequency network, the Internet, etc.

The merchant 112 may receive the payment details associated with the payment card 108 and may submit the payment details along with additional transaction data to the payment network 104 for processing of the payment transaction. The additional transaction data may include, for example, a transaction time and/or date, transaction amount, geographic location, consumer data (e.g., name, shipping address, billing address, e-mail address, phone number, etc.), merchant data (e.g., name, identifier, street address, industry, category code, etc.), product data (e.g., identifier, name, amount, size, quantity, color, description, etc.), point of sale data (e.g., identifier, media access control address, internet protocol address, registration number, geographic location, etc.), offer data (e.g., identifier, name, description, amount, type, expiration date, quantity, etc.), loyalty data (e.g., identifier, type, level, value, etc.), reward data (e.g., identifier, value, cost, etc.), etc. The transaction details may be submitted to the payment network 104 via the payment rails and may be submitted directly to the merchant 112 or via one or more intermediate entities, such as gateway processors and/or acquiring financial institutions, such as the acquirer 113, which may be an acquiring bank or other entity associated with a transaction account of the merchant 112. The submission of transaction details from a merchant 112 to a payment network 104 are discussed in more detail below with respect to the process 700 illustrated in FIG. 7.

The payment network 104 may receive the transaction details included in a transaction message. A transaction message may be a specially configured and formatted data message that is formatted pursuant to one or more standards governing the exchange of financial transaction messages, such as the International Organization of Standardization's ISO 8583 standard. The transaction message may include a plurality of data elements configured to store data as set forth in the associated standard(s), such as a data element configured to store a primary account number, a data element configured to store a transaction amount, a data element configured to store an institution identifier associated with an issuer 110, and additional data elements that may be configured to store additional payment details and other transaction data. In some instances, a transaction message may also include a message type indicator, which may indicate a type of the transaction message suitable for use in processing of the related payment transaction and routing of the transaction message. For example, transaction messages submitted to the payment network 104 via the payment rails from the merchant 112 or associated intermediate entity may include a message type indicator indicative of an authorization request.

The payment network 104 may forward the transaction message to the processing server 102 for processing. The processing server 102 may perform one or more services associated with the transaction message for the processing thereof. Services may include the calculation of a fraud score for the payment transaction using one or more fraud algorithms that may be applied to the payment transaction to calculate a score indicative of a likelihood of fraud. Fraud algorithms may utilize transaction data stored in the data elements of the transaction message, account data associated with the transaction account used to fund the payment transaction, data associated with the merchant 112 involved in the payment transaction, and additional data that will be apparent to persons having skill in the relevant art. The processing server 102 may electronically transmit the transaction message to the issuer 110 associated with the transaction account used to fund the payment transaction using the payment rails. In some embodiments, the processing server 102 may electronically transmit the fraud score or other data identified as a result of the processing of services in a data signal used to transmit the transaction message or an accompanying data signal. In other embodiments, the fraud score or other data may be stored in one or more data elements included in the transaction message prior to transmission of the transaction message to the issuer 110.

The issuer 110 may receive the transaction message and may decline the related payment transaction. The issuer 110 may decline the payment transaction based on the fraud score provided by the processing server 102. In some instances, the decline may additionally, or alternatively, be based on one or more additional criteria associated with the payment transaction, such as an account balance or credit limit of the transaction account, data associated with the merchant 112, a geographic location of the payment transaction and geographic location associated with the transaction account, etc. For instance, in one example, the payment transaction may be a cross border transaction with the merchant 112 located in a country that the issuer 110 declines transactions from out of concern for fraud. Once declined, the issuer 110 may transmit a response transaction message to the processing server 102 via the payment network 104 using the payment rails. The response transaction message may include a data element configured to store a response code that indicates the decline of the payment transaction. In some instances, the response code may indicate that the transaction was declined due to a concern for fraud.

The processing server 102 may receive and parse the transaction message, which may deconstruct the transaction message and identify the data stored in the data elements included therein. The processing server 102 may identify the response code indicating that the payment transaction is declined. In a traditional payment transaction, such as discussed below with respect to the process 700 illustrated in FIG. 7, the processing server 102 may forward the response transaction message to the merchant 112 via one or more intermediate entities using the payment network 104, who may then finalize the payment transaction with the consumer 106 based thereon. In the system 100, the processing server 102 may electronically transmit the transaction message or data associated therewith to a secondary financial institution 114 for secondary processing of the payment transaction.

The secondary financial institution may be any type of entity, including entities traditionally considered to be non-financial institutions (which may be considered financial institutions in the system 100 discussed herein as a result of their involvement in the system 100 and process discussed herein) that may be willing to accept the risk of fraud for the payment transaction and thereby approve a payment transaction previously declined by the issuer 110. For example, the secondary financial institution may be an individual and/or a broker willing to accept the risk of fraud for the payment transaction. The secondary financial institution 114 may receive the transaction message or associated data from the processing server 102 and may determine that the risk for the payment transaction is acceptable, such as based on the fraud score, data stored in the data elements of the transaction message, and other associated data.

For example, the issuer 110 may decline any payment transaction if the payment transaction is a cross border transaction and the merchant 112 involved in the transaction is located in a specific country, without regard to a likelihood of fraud considering other factors specific to individual payment transactions. Conversely, the secondary financial institution 114 may not decline all cross border transactions involving merchants 112 in the specific country. As such, the secondary financial institution 114 may evaluate the payment transaction declined by the issuer 110 and accept the risk that the transaction may be fraudulent, and may decide to approve the payment transaction in place of the issuer 110. The secondary financial institution 114 may indicate thusly to the processing server 102 in a response transaction message or a separate data signal electronically transmitted to the processing server 102 by the secondary financial institution 114 using the payment rails or an alternative communication network.

In some instances, the processing server 102 may only transmit a portion of the data associated with the payment transaction to the secondary financial institution 114 for secondary processing. For example, the processing server 102 may transmit only the fraud score and the transaction amount to the secondary financial institution 114, for use in determining secondary approval of the transaction. In another example, the processing server 102 may transmit any transaction data suitable for determining approval or declining of the payment transaction by the secondary financial institution 114 that does not include any information directly associated with the consumer 106 and/or transaction account, such as the primary account number, consumer data, etc.

The processing server 102 may then continue processing the payment transaction, such as by forwarding a transaction message indicative of being an authorization response to the merchant 112 (e.g., via one or more intermediate entities) using the payment network 104 that includes a response code indicating approval of the payment transaction. In some embodiments, the processing server 102 may first replace an institution identifier stored in a corresponding data element in the transaction message that is associated with the issuer 110 with an institution identifier associated with the secondary financial institution 114. In other embodiments, additional data elements included in the transaction message may be updated to include the institution identifier associated with the secondary financial institution 114 and an indication that the payment transaction is subject to secondary processing.

In some embodiments, the processing server 102 may be configured to identify payment transactions where the issuer 110 may decline the payment transaction prior to the transmission of the transaction message to the issuer 110. For example, the issuer 110 may provide criteria for which payment transactions are to be declined, such as specific transaction details stored in one or more data elements (e.g., a geographic location, indication of a cross border transaction, etc.), a specific fraud score (e.g., decline any transaction above a predetermined fraud score limit), etc. In such embodiments, the processing server 102 may decline the payment transaction on behalf of the issuer 110 based on the criteria, and may proceed with secondary processing of the payment transaction prior to, or without, transmitting a transaction message to the issuer 110. In some instances, the processing server 102 may transmit the transaction message or other data signal to the issuer 110 as a notification. In some cases, if a secondary financial institution 114 accepts the risk for the payment transaction, the processing server 102 may transmit the transaction message or a notification to the issuer 110 indicative thereof. In some such cases, the processing server 102 may transmit the transaction message to the issuer 110 for approval of the payment transaction with respect to non-fraud considerations, such as for approval that the transaction account has sufficient funds or credit, that the transaction satisfies any account controls, etc.

In some embodiments, the processing server 102 may identify a secondary financial institution 114 based on criteria provided by the secondary financial institution 114. For example, a secondary financial institution 114 may indicate to the processing server 102 a willingness to accept payment transactions that fit specific criteria (e.g., based on transaction details stored in data elements included in corresponding transaction messages, fraud scores, etc.). In such instances, the processing server 102 may identify the secondary financial institution 114 for secondary processing in declined payment transactions satisfying the criteria. In some cases, an issuer 110 may indicate a preferred secondary financial institution 114.

In some embodiments, a plurality of secondary financial institutions 114 may be available for secondary processing of a payment transaction. In such embodiments, the processing server 102 may be configured to select a specific secondary financial institution 114 for use in secondary approval of the payment transaction. In one example, the processing server 102 may rotate through available secondary financial institutions 114, such as by alternating between secondary financial institutions 114 for each payment transaction. In another example, the processing server 102 may alternate secondary financial institutions 114 such that aggregate transaction amounts or processing fees are kept close. For instance, the processing server 102 may select a secondary financial institution 114 that has received the least amount in processing fees for payment transactions during a predetermined period of time (e.g., last thirty days).

In yet another example, secondary financial institutions 114 may bid on declined payment transactions. For instance, secondary financial institutions 114 may bid via waiving of a processing fee amount, may financially bid for a declined payment transaction, or may bid using other suitable leverage, method, or criteria. In some cases, secondary financial institutions 114 may bid for multiple payment transactions, such as all payment transactions fitting specific criteria (e.g., fraud score, issuer 110, transaction amount, etc.), all payment transactions for a specific period of time, etc. In some instances, secondary financial institutions 114 may bid in real-time or near real-time once a declined payment transaction is identified by the processing server 102 (e.g., via receipt of a response transaction message from the issuer 110 indicating decline of the payment transaction). In some embodiments, bidding secondary financial institutions 114 may be prioritized, such as using one or more algorithms configured therefor (e.g., based on a rotating order, fee revues, processing time, randomization, etc.), where the highest priority secondary financial institution 114 is contacted for acceptance of the risk, and, if the risk is not accepted, the next secondary financial institution 114 in order of priority is contacted, and so on, until the risk is accepted for the payment transaction.

In some embodiments, once the transaction has been authorized and processed, the payment transaction may be settled and cleared by the payment network 104 and/or processing server 102 using traditional methods and systems. In some cases, any processing fees that may be traditionally paid to the issuer 110 may be paid to the secondary financial institution 114 due to the acceptance of risk. In other embodiments, the issuer 110 may pay the transaction amount for the payment transaction to the secondary financial institution 114. In such embodiments, the secondary financial institution 114 may replace the issuer 110 during clearing and settlement for the payment transaction. In instances where a payment transaction is determined to be fraudulent, the secondary financial institution 114 may be held liable. In such instances, the secondary financial institution 114 may pay restitution for the fraudulent transaction to the consumer 106 or merchant 112 due to the fraud. In instances where a payment transaction is charged back, the issuer 110 may return funds to the transaction account used in the payment transaction via traditional methods. In some cases, the clearing and settlement records may indicate payment transactions where the secondary financial institution 114 has accepted risk for the payment transaction. In such cases, clearing and/or settlement records may be provided to both the issuer 110 and the secondary financial institution 114, such as for record keeping and processing purposes. For instance, the issuer 110 may receive a clearing message and settlement record to ensure that payment is made to the acquirer 113 and/or merchant 112 and deducted from the consumer 106 transaction account, and the secondary financial institution 114 may receive the clearing message and/or settlement record as an indication that the transaction was cleared and settled successfully.

The methods and systems discussed herein provide for a technical improvement to transaction processing systems whereby the processing server 102 accomplishes secondary processing of declined payment transactions via the use of transaction messaging and a secondary financial institution 114. By performing secondary processing, the processing server 102 can facilitate the processing of payment transactions that may be otherwise declined by an issuer 110, to provide for greater success in conducting payment transactions for consumers 106 and increasing revenue for secondary financial institutions 114, while not subjecting an issuer 110 to any additional risk.

### Processing Server

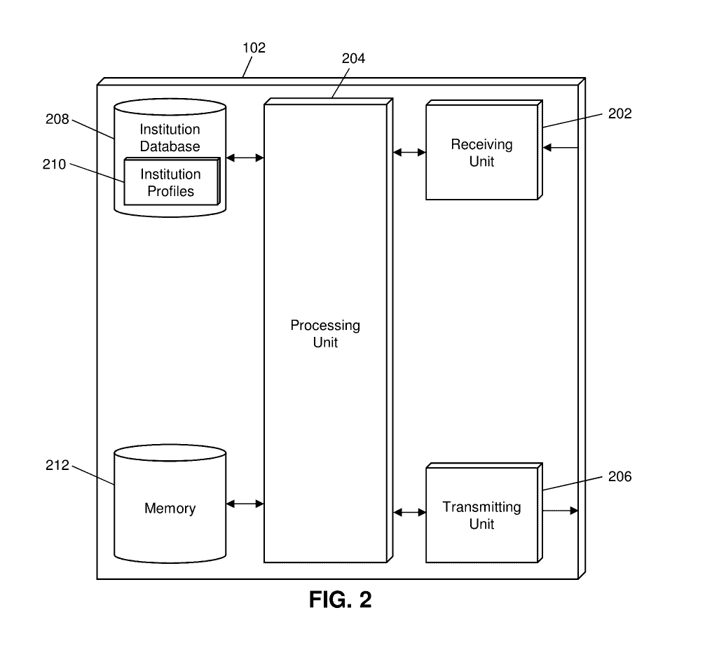

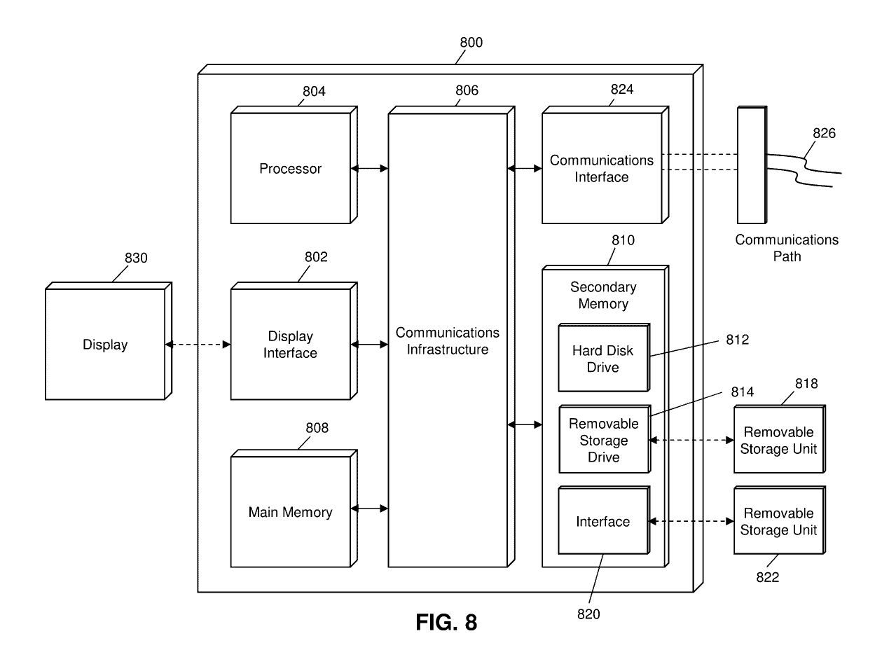

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving unit 202. The receiving unit 202 may be configured to receive data over one or more networks via one or more network protocols. In some embodiments, the receiving unit 202 may be configured to receive data over the payment rails, such as using specially configured infrastructure associated with payment networks 104 for the transmission of transaction messages that include sensitive financial data and information. In some instances, the receiving unit 202 may also be configured to receive data from merchants 112, issuers 110, secondary financial institutions 114, the payment network 104, and other entities via alternative networks, such as the Internet. In some embodiments, the receiving unit 202 may be comprised of multiple units, such as different receiving units for receiving data over different networks, such as a first receiving unit for receiving data over payment rails and a second receiving unit for receiving data over the Internet. The receiving unit 202 may receive electronically data signals that are transmitted, where data may be superimposed on the data signal and decoded, parsed, read, or otherwise obtained via receipt of the data signal by the receiving unit 202. In some instances, the receiving unit 202 may include a parsing module for parsing the received data signal to obtain the data superimposed thereon.

The receiving unit 202 may be configured to receive transaction messages from the payment network 104 (e.g., or from other entities as transmitted to the processing server 102 via the payment network 104, such as the merchant 112, issuer 110, and secondary financial institution 114) for payment transactions. Transaction messages may be authorization requests, authorization responses, or other types of transaction messages suitable for performing the functions disclosed herein. Transaction messages may be formatted based on one or more standards, such as the ISO 8583 standard, and include data elements configured to store a primary account number, a transaction amount, an institution identifier, and additional transaction data.

The primary account number may be an account number associated with a transaction account used to fund the payment transaction. The issuer identifier may be a unique value associated with a financial institution associated with the transaction account, such as the issuer 110. The identifier may be, for example, an identification number, registration number, payment network destination address, media access control address, serial number, or other suitable value that will be apparent to persons having skill in the relevant art. The receiving unit 202 may also be configured to receive additional data signals electronically transmitted via one or more communication networks, such as data signals transmitted by issuers 110 and secondary financial institutions superimposed with preference data, which may include preferences for denial or approval of payment transactions. The receiving unit 202 may also receive data signals superimposed with bid data associated with bids for declined payment transactions by secondary financial institutions 114.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. For example, the processing unit 204 may include a querying module configured to query databases included in the processing server 102 to identify information stored therein. In some instances, the processing unit 204 may include a parsing module or engine configured to parse data from data signals electronically received by the receiving unit 202, an encryption module or engine configured to decrypt received data or data signals or to encrypt data or data signals received or transmitted by the processing server 102, and any other modules suitable for performing the functions discussed herein.

The processing unit 204 may include a fraud scoring module. The fraud scoring module may be configured to receive a transaction message and/or data elements included therein and parsed therefrom as input, may apply one or more fraud algorithms to the data, and may output a fraud score. Fraud algorithms may be stored in an internal database of the processing server 102 or in a database external to the processing server 102 and accessed via one or more communication networks. In some instances, fraud algorithms may be selected based on preferences of an issuer 110 associated with a payment transaction (e.g., as identified using the institution identifier stored in the corresponding data element in the transaction message) or other data, such as data stored in the data elements included in the transaction message. For example, different fraud algorithms may be utilized dependent on a geographic location or transaction amount of the payment transaction.

The processing unit 204 may further include a transaction processing module. The transaction processing module 204 may be configured to process transaction messages for payment transactions. The transaction processing module may be configured to receive a transaction message, identify an action to be performed based on the transaction message, and output an instruction to an appropriate module and/or device of the processing server 102 for performance of the action. For instance, if the transaction processing module receives an authorization request for a payment transaction that has not been scored, the transaction processing module may instruct the fraud scoring module to calculate a fraud score for the authorization request. If the transaction processing module receives an authorization request for a payment transaction that has been scored by the fraud scoring module, the transaction processing module may send (e.g., via an internal communication network and/or method) an instruction to a transmitting unit 206 to transmit the transaction message and fraud score to the issuer 110 associated with the payment transaction. In some instances, the transaction processing module may first store the fraud score in a corresponding data element included in the transaction message.

The transmitting unit 206 may be configured to transmit data over one or more networks via one or more network protocols. In some embodiments, the transmitting unit 206 may be configured to transmit data over the payment rails, such as using specially configured infrastructure associated with payment networks 104 for the transmission of transaction messages that include sensitive financial data and information, such as identified payment credentials. In some instances, the transmitting unit 206 may be configured to transmit data to issuers 110, payment networks 104, merchants 112, secondary financial institutions 114, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet. The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The transmitting unit 206 may be configured to electronically transmit authorization requests and other transaction messages to the issuer 110 via the payment network. In some instances, a transaction message may be superimposed in a data signal electronically transmitted to the issuer 110. In some cases, the data signal may also be superimposed with a fraud score or other additional data for use by the issuer 110 in approving or declining the related payment transaction. In other cases, the transmitting unit 206 may electronically transmit a separate data signal superimposed with the fraud score or other additional data. The transmitting unit 206 may also be configured to transmit data signals to the issuer 110 superimposed with notifications, such as a notification indicating secondary processing of a declined payment transaction by a secondary financial institution 114. The transmitting unit 206 may also be configured to transmit data signals superimposed with transaction messages and notifications, as well as data signals superimposed with transaction data for the bidding on one or more payment transactions, to secondary financial institutions 114.

The transaction processing module of the processing unit 204 may also be configured to identify secondary financial institutions 114 for use in secondary processing of payment transactions. For instance, the transaction processing module may identify criteria set forth by the secondary financial institution 114 and use such criteria to determine if the secondary financial institution 114 is to receive a transaction message for a declined payment transaction for approval thereof. In some instances, the transaction processing module may be configured to approve a payment transaction on behalf of a secondary financial institution 114 based on criteria and/or preferences provided by the secondary financial institution. In some embodiments, the transaction processing module may be configured to decline payment transactions on behalf of issuers 110 based on criteria and/or preferences provided thereby.

The processing server 102 may include an institution database 208. The institution database 208 may be configured to store a plurality of institution profiles 210 using a suitable data storage format and schema. Each institution profile 210 may include a standardized data set of data related to a financial institution, which may be standardized across each of the plurality of institution profiles 210. The institution profile 210 may include at least an institution identifier associated with the related financial institution, and may further include preferences and/or criteria associated with the related financial institution. Preferences and/or criteria may include preferences or criteria for declining payment transactions, for secondary approval of payment transactions, for bidding of payment transactions for secondary approval, for notifications associated with secondary processing of payment transactions, etc.

The processing unit 204 may include a querying module. The querying module may receive a query string as input, may execute a query on a database of the processing server 102 using the query string, and may output data identified as a result thereof. For example, the querying module may be configured to execute a query on the institution database 208 to identify an institution profile 210 that includes an institution identifier corresponding to an institution identifier stored in a corresponding data element included in (e.g., parsed from) a received transaction message. In such an example, the querying module may identify the institution profile 210 as a result of an instruction provided by the transaction processing module, which may be configured to use data stored in the identified institution profile 210 to approve or decline a payment transaction based thereon.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for modules and application programs of the processing unit 204, and other data that may be suitable for use by the processing server 102 in the performance of the functions disclosed herein as will be apparent to persons having skill in the relevant art.

### First Process for Secondary Processing of a Declined Payment Transaction

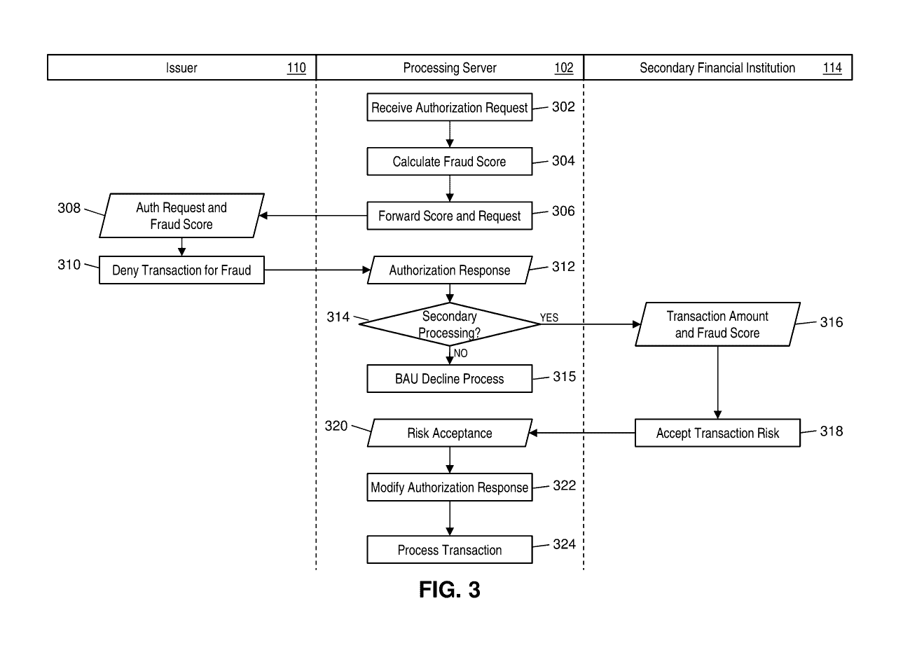

FIG. 3 illustrates a process for the secondary processing of a declined payment transaction by a secondary financial institution 114 following decline of the payment transaction by an issuer 110.

In step 302, the receiving unit 202 of the processing server 102 may receive an authorization request via the payment network 104 electronically transmitted using the payment rails. The authorization request may be a transaction message formatted pursuant to one or more standards, such as the ISO 8583 standard, that includes a message type indicator indicative of being an authorization request, that includes data elements configured to store a primary account number, a transaction amount, an institution identifier, and additional transaction data. The authorization request may be parsed by the receiving unit 202 or processing unit 204 of the processing server 102 for deconstruction and identification of the data stored therein.

In step 304, the fraud scoring module of the processing unit 204 of the processing server 102 may calculate a fraud score for the payment transaction. The fraud score may be calculated via application of one or more fraud algorithms to the data stored in the data elements included in the received authorization request. In step 306, the transmitting unit 206 of the processing server 102 may electronically transmit the authorization request and fraud score in a data signal transmitted to the issuer 110 via the payment network 104 using the payment rails or another suitable communication network. The issuer 110 may be identified for transmitting of the authorization request and fraud score using the institution identifier and/or primary account number parsed from the received transaction message.

In step 308, the issuer 110 may receive the authorization request and fraud score. In step 310, the issuer 110 may deny the payment transaction due to fraud concerns based on the fraud score and/or additional transaction data stored in the authorization request. The denial of the payment transaction may include the generation of an authorization response, which may be a transmitted message that includes a message type indicator indicative of an authorization response that includes the transaction data included in the authorization request and also includes a response code indicating the declining of the payment transaction. In some instances, the authorization response may also include, such as in a corresponding data element or an addendum to the transaction message, an indication that the transaction account associated with the payment transaction (e.g., based on the primary account number) includes sufficient funds and/or credit for the payment transaction.

The authorization response may be transmitted to the processing server 102 by the issuer 110 via the payment rails and, in step 312, received by the receiving unit 202 of the processing server 102. In step 314, the transaction processing module of the processing unit 204 may identify that the transaction was declined by the issuer 110, but may determine if secondary processing is to be performed via the acceptance of risk for the transaction by a secondary financial institution 114. The determination may be made, for instance, based on data included in the authorization, such as a data element indicating that the issuer 110 accepts secondary processing, prior indication received from the issuer 110, if the calculated fraud score is within a predetermined threshold identified by the secondary financial institution 114, etc. If the transaction is not eligible for secondary processing, such as by request of the issuer 110 or the calculated fraud score being above a threshold set by the secondary financial institution, then, in step 315, the processing server 102 may continue processing the declined payment transaction using traditional business as usual (BAU) processes. If the transaction is eligible for secondary processing, then the processing server 102 may identify the secondary financial institution 114 for secondary processing and may instruct the transmitting unit 206 of the processing server 102 to electronically transmit a data signal superimposed with at least the fraud score and transaction amount to the secondary financial institution 114. The data signal may be electronically transmitted via the payment network 104 using the payment rails, or may be transmitted via another suitable communication network.

In step 316, the secondary financial institution 114 may receive the transaction amount and fraud score and, in step 318, may decide to accept the risk of fraud for the payment transaction based thereon. The secondary financial institution 114 may electronically transmit a data signal back to the processing server 102 using the payment rails or other suitable communication network that is superimposed with an indication of acceptance of risk for the payment transaction. In step 320, the receiving unit 202 of the processing server 102 may receive the data signal from the secondary financial institution 114.

In step 322, the transaction processing module of the processing unit 204 may be configured to modify the authorization response by modifying the data element configured to store the institution identifier included in the authorization response to store an institution identifier associated with the secondary financial institution 114 instead of the issuer 110. The authorization response may also be modified by updating of the response code to indicate approval of the payment transaction, and additional modifications, such as for storage of an indication of secondary processing for the payment transaction. In step 324, the transaction processing module may continue processing of the payment transaction using traditional methods, such as by forwarding the authorization response to an acquiring financial institution associated with a merchant 112 involved in the payment transaction, as may be identified by data stored in the data elements included in the authorization response.

### Second Process for Secondary Processing of a Declined Payment Transaction

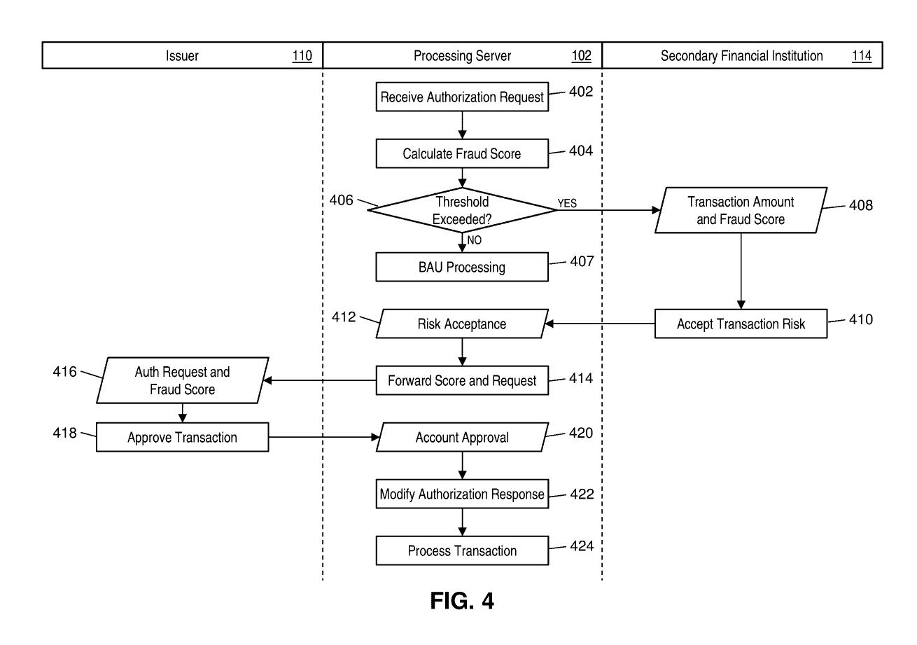

FIG. 4 illustrates a process for pre-emptory secondary processing of a payment transaction by a secondary financial institution 114 for a payment transaction that is predetermined to be declined by an issuer 110. This process is similar to the process shown in FIG. 3, but differs as to when the secondary financial institution accepts the transaction risk. Specifically, in the process illustrated in FIG. 4, the secondary financial institution 114 is contacted to accept the risk prior to requesting approval of the issuer 110.

In step 402, the receiving unit 202 of the processing server 102 may receive an authorization request via the payment network 104 electronically transmitted using the payment rails. The authorization request may be a transaction message formatted pursuant to one or more standards, such as the ISO 8583 standard, that includes a message type indicator indicative of being an authorization request, that includes data elements configured to store a primary account number, a transaction amount, an institution identifier, and additional transaction data. The authorization request may be parsed by the receiving unit 202 or processing unit 204 of the processing server 102 for deconstruction and identification of the data stored therein.

In step 404, the fraud scoring module of the processing unit 204 of the processing server 102 may calculate a fraud score for the payment transaction. The fraud score may be calculated via application of one or more fraud algorithms to the data stored in the data elements included in the received authorization request. In step 406, the processing unit 204 of the processing server 102 may determine if the fraud score exceeds a predetermined threshold associated with the issuer 110 involved in the payment transaction. For example, the issuer 110 may have previously established a threshold with the processing server 102 such that any transaction with a fraud score above the threshold is to be declined, such as to increase processing speed and efficiency for payment transactions. If the fraud score is within the issuer's predetermined threshold, then, in step 407, the processing server 102 may proceed to process the transaction using traditional BAU processes, such as illustrated in the process 700 in FIG. 7 and discussed below. If, in step 406, the processing unit 204 determines that the calculated fraud score is above the issuer's predetermined threshold, then the transmitting unit 206 of the processing server 102 may electronically transmit electronically transmit a data signal superimposed with at least the fraud score and transaction amount to a secondary financial institution 114 for acceptance of the risk. The data signal may be electronically transmitted via the payment network 104 using the payment rails, or may be transmitted via another suitable communication network.

In step 408, the secondary financial institution 114 may receive the transaction amount and fraud score from the transmitting unit 206 of the processing server 102. In step 410, the secondary financial institution 114 may decide to accept the risk of fraud for the payment transaction based thereon. The secondary financial institution 114 may electronically transmit a data signal back to the processing server 102 using the payment rails or other suitable communication network that is superimposed with an indication of acceptance of risk for the payment transaction. In step 412, the receiving unit 202 of the processing server 102 may receive the indication of acceptance of risk from the secondary financial institution 114. In step 414, the transaction processing module of the processing unit 204 may identify that the secondary financial institution 114 accepted the transaction risk, and may instruct the transmitting unit 206 of the processing server 102 to electronically transmit a data signal superimposed with at least the fraud score, authorization request, and the an indication of the acceptance of the transaction risk by the secondary financial institution 114 to the issuer 110. The data may be electronically transmitted via the payment network 104 using the payment rails, or may be transmitted via another suitable communication network. In some instances, the fraud score and/or indication may be included in one or more data elements included in the authorization request.

In step 416, the issuer 110 may receive the authorization request, indication of the secondary financial institution's acceptance of risk, and fraud score. In step 418, the issuer 110 may approve the payment transaction due to the assumption of the transaction risk secondary financial institution 114 in step 410 conveyed with the fraud score and/or additional transaction data stored in the authorization request. The approval of the payment transaction may include the generation of an authorization response, which may be a transmitted message that includes a message type indicator indicative of an authorization response that includes the transaction data included in the authorization request and also includes a response code indicating the approving or authorizing the payment transaction. In some instances, the authorization response may also include, such as in a corresponding data element or an addendum to the transaction message, an indication that the transaction account associated with the payment transaction (e.g., based on the primary account number) includes sufficient funds and/or credit for the payment transaction and optionally that the risk was assumed by the secondary financial institution 114.

In step 420, the receiving unit 202 of the processing server 102 may receive this data signal carrying the authorization response from the issuer 418. In step 422, the transaction processing module of the processing unit 204 may be configured to modify the authorization response by modifying the data element configured to store the institution identifier included in the authorization response to store an institution identifier associated with the secondary financial institution 114 instead of the issuer 110. The authorization response may also be modified by updating of the response code to indicate approval of the payment transaction, and additional modifications, such as for storage of an indication of secondary processing for the payment transaction. In step 424, the transaction processing module may continue processing of the payment transaction using traditional methods, such as by forwarding the authorization response to an acquiring financial institution associated with a merchant 112 involved in the payment transaction, as may be identified by data stored in the data elements included in the authorization response.

### Third Process for Secondary Processing of a Declined Payment Transaction

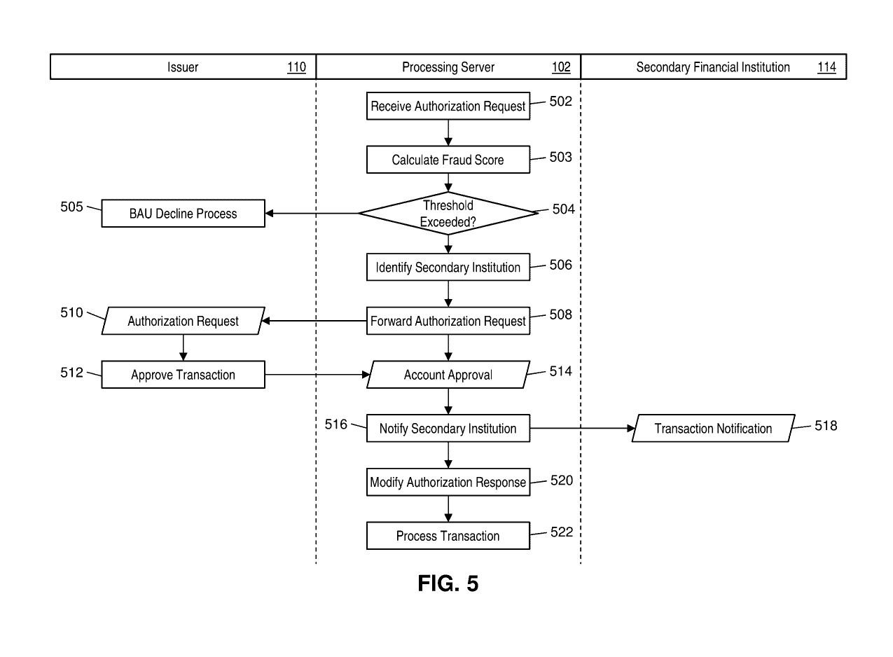

FIG. 5 illustrates a process for the secondary processing of a declined payment transaction for which risk is accepted on behalf of a secondary financial institution 114 by the transaction processor prior to transmission of the authorization request to the issuer 110.

In step 502, the receiving unit 202 of the processing server 102 may receive an authorization request via the payment network 104 electronically transmitted using the payment rails. The authorization request may be a transaction message formatted pursuant to one or more standards, such as the ISO 8583 standard, that includes a message type indicator indicative of being an authorization request, that includes data elements configured to store a primary account number, a transaction amount, an institution identifier, and additional transaction data. The authorization request may be parsed by the receiving unit 202 or processing unit 204 of the processing server 102 for deconstruction and identification of the data stored therein.

In step 503, the fraud scoring module of the processing unit 204 of the processing server 102 may calculate a fraud score for the payment transaction. The fraud score may be calculated via application of one or more fraud algorithms to the data stored in the data elements included in the received authorization request. In step 504, the processing unit 204 of the processing server 102 may determine if a threshold set by the issuer 110 for the fraud score is exceeded by the fraud score calculated for the payment transaction. For example, the issuer 110 may have previously established a threshold with the processing server 102 such that any transaction with a fraud score above the threshold is to be declined, such as to increase processing speed and efficiency for payment transactions. If the threshold is not exceeded, then, in step 505, the processing server 102 may forward the authorization request and calculated fraud score to the issuer 110 for traditional BAU processing of the payment transaction, such as using the process 700 illustrated in FIG. 7 and discussed below. If the threshold is exceeded by the calculated fraud score, then, in step 506, the transaction processing module of the processing unit 204 may identify a secondary financial institution 114 that may be willing to accept the risk for the payment transaction. The identification may be based on, for example, criteria and/or preferences stored in an institution profile 210 associated with the secondary financial institution 114 and transaction data stored in the data elements included in the authorization request and the fraud score. In some instances, the secondary financial institution 114 may be identified upon a determination by the transaction processing module that the issuer 110 is not willing to accept the risk for the payment transaction, such as based on preferences and/or criteria of the issuer 110 and the transaction data.

In step 508, the transaction processing module of the processing unit 204 may be configured to instruct the transmitting unit 206 of the processing server 102 to electronically transmit a data signal superimposed with the authorization to the issuer 110 using the payment rails. In some instances, the data signal may also include an indication of acceptance of the transaction risk by a secondary financial institution 112. In some cases, the indication may not individually identify the secondary financial institution 114 that accepted the risk. The issuer 110 may be identified for transmitting of the authorization request and fraud score using the institution identifier and/or primary account number parsed from the received transaction message.

In step 510, the issuer 110 may receive the authorization request and fraud score. In step 512, the issuer 110 may approve the payment transaction for secondary processing. The approval of the payment transaction for secondary processing may include the approval of the transaction account for use in funding the payment transaction (e.g., based on an account balance and/or available credit), even in instances where the issuer 110 may not be willing to accept a risk of fraud. The issuer 110 may still approve the transaction due to the acceptance of the risk as indicated by the secondary financial institution 114. Approval of the payment transaction may include the generation of an authorization response, which may be a transmitted message that includes a message type indicator indicative of an authorization response that includes the transaction data included in the authorization request. The authorization response may be transmitted to the processing server 102 by the issuer 110 via the payment rails and, in step 514, received by the receiving unit 202 of the processing server 102. In some instances, the approval may be included in data that may not comprise an authorization response, which may be transmitted to the processing server 102 and received by the receiving unit 202.

In step 516, the transmitting unit 206 of the processing server 102 may electronically transmit a data signal to the secondary financial institution via the payment rails or an alternative communication network that is superimposed with a notification regarding the payment transaction. In step 518, the secondary financial institution 114 may receive the notification. The notification may notify the secondary financial institution 114 that the payment transaction was approved by the issuer 110 for acceptance of risk by the secondary financial institution 114, with the notification further including any transaction data that may be necessary for processing by the secondary financial institution 114, such as the transaction amount, merchant data, etc.

In step 520, the transaction processing module of the processing unit 204 may be configured to modify the authorization response by modifying the data element configured to store the institution identifier included in the authorization response to store an institution identifier associated with the secondary financial institution 114 instead of the issuer 110. The authorization response may also be modified by updating of the response code to indicate approval of the payment transaction, and additional modifications, such as for storage of an indication of secondary processing for the payment transaction. In step 522, the transaction processing module may continue processing of the payment transaction using traditional methods, such as by forwarding the authorization response to an acquiring financial institution associated with a merchant 112 involved in the payment transaction, as may be identified by data stored in the data elements included in the authorization response.

### Exemplary Method for Processing a Declined Payment Transaction Using a Secondary Financial Institution

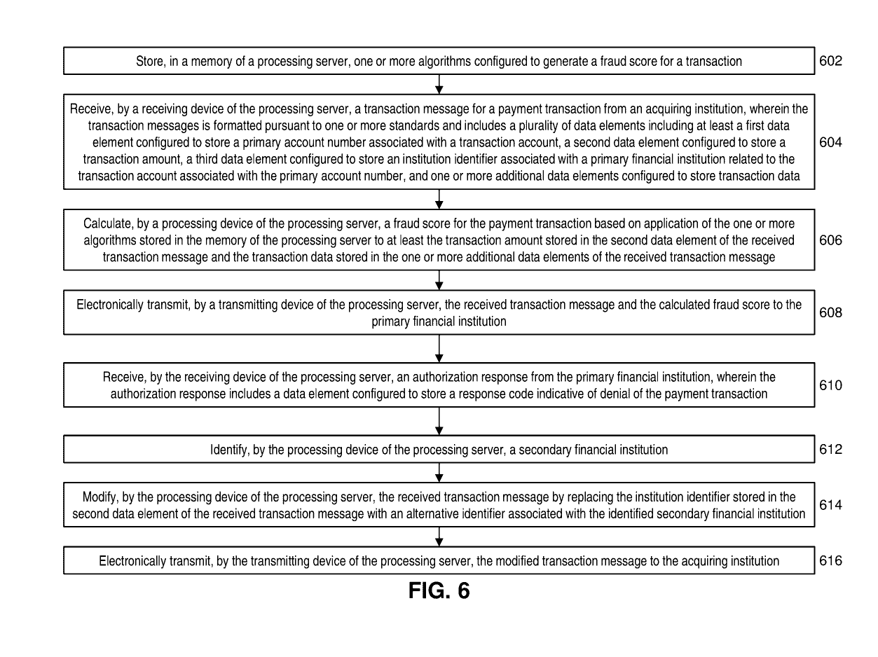

FIG. 6 illustrates a method 600 for the processing of a payment transaction declined by an issuing financial institution via acceptance of risk for the payment transaction by a secondary financial institution.

In step 602, one or more algorithms configured to generate a fraud score for a transaction may be stored in a memory (e.g., memory 212) of a processing server (e.g., the processing server 102). In step 604, a transaction message for a payment transaction may be received by a receiving device (e.g., the receiving unit 202) of the processing server, wherein the transaction message is formatted pursuant to one or more standards and includes a plurality of data elements including at least a first data element configured to store a primary account number associated with a transaction account, a second data element configured to store a transaction amount, a third data element configured to store an institution identifier associated with a primary financial institution (e.g., the issuer 110) related to the transaction account associated with the primary account number, and one or more additional data elements configured to store transaction data.

In step 606, a fraud score may be calculated by a processing device (e.g., the processing unit 204) for the payment transaction based on application of the one or more algorithms stored in the memory of the processing server to at least the transaction amount stored in the second data element of the received transaction message and the transaction data stored in the one or more additional data elements of the received transaction message. In step 608, the received transaction message and the calculated fraud score may be electronically transmitted to the primary financial institution by a transmitting device (e.g., the transmitting unit 206) of the processing server.

In step 610, an authorization response may be received from the primary financial institution by the receiving device of the processing server, wherein the authorization response includes a data element configured to store a response code indicative of denial of the payment transaction. In step 612, the processing device of the processing server may identify a secondary financial institution (e.g., secondary financial institution 114).

In step 614, the received transaction message may be modified by the processing device of the processing server by replacing the institution identifier stored in the second data element of the received transaction message with an alternative identifier associated with the identified secondary financial institution. In step 616, the modified transaction message may be electronically transmitted by the transmitting device of the processing server to the acquiring institution.

In one embodiment, modifying the received transaction message may further include modifying a message type indicator indicative of an authorization response and modifying a response code stored in a fourth data element included in the transaction message to indicate approval of the payment transaction. In some embodiments, the response code stored in the data element of the authorization response may indicate denial of the payment transaction related to fraud based on the calculated fraud score.

In one embodiment, the electronic transmission to the primary financial institution may be subsequent to identification of the secondary financial institution, and the electronic transmission to the primary financial institution may further include an indication of acceptance of risk by the identified secondary financial institution. In a further embodiment, the method 600 may even further include: storing, in the memory of the processing server, an acceptance threshold associated with the primary financial institution, wherein the calculated fraud score exceeds the stored acceptance threshold.

In some embodiments, the identification of the secondary financial institution may include: electronically transmitting, by the transmitting device of the processing server, at least the transaction amount stored in the second data element of the received transaction message and the calculated fraud score to the secondary financial institution; and receiving, by the receiving device of the processing server, an indication of acceptance of risk from the secondary financial institution. In one embodiment, the method 600 may also include: storing, in the memory of the processing server, an acceptance threshold associated with the secondary financial institution, wherein identification of the secondary financial institution comprises determining, by the processing device of the processing server, that the calculated fraud score does not exceed the acceptance threshold associated with the secondary financial institution.

In some embodiments, the payment transaction may be a cross border transaction. In one embodiment, the transaction data may include at least one of: geographic location, transaction time and/or date, merchant category code, merchant identification number, merchant data, product data, loyalty data, reward data, and offer data. In some embodiments, the one or more standards may include the ISO 8583 standard.

### Payment Transaction Processing System and Process

FIG. 7 illustrates a transaction processing system and a process 700 for the processing of payment transactions in the system. The process 700 and steps included therein may be performed by one or more components of the system 100 discussed above, such as the merchants 112, issuers 110, secondary financial institutions 114, processing server 102, and payment network 104. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to process payment transactions. It will be apparent to persons having skill in the relevant art that the process 700 may be incorporated into the processes illustrated in FIGS. 3-6, discussed above, with respect to the step or steps involved in the processing of a payment transaction. In addition, the entities discussed herein for performing the process 700 may include one or more computing devices or systems configured to perform the functions discussed below. For instance, the merchant 704 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicate electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 708 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 740 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement, for example, the methods of FIGS. 3-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for processing a declined payment transaction using a secondary financial institution. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a declined payment transaction using a secondary financial institution, comprising:
storing, in a memory of a processing server, one or more algorithms configured to generate a fraud score for a transaction;
receiving, by a receiving device of the processing server, a transaction message for a payment transaction from an acquiring institution, wherein the transaction message is formatted pursuant to one or more standards and includes a plurality of data elements including at least a first data element configured to store a primary account number associated with a transaction account, a second data element configured to store a transaction amount, a third data element configured to store an institution identifier associated with a primary financial institution related to the transaction account associated with the primary account number, and one or more additional data elements configured to store transaction data;
calculating, by a processing device of the processing server, a fraud score for the payment transaction based on application of the one or more algorithms stored in the memory of the processing server to at least the transaction amount stored in the second data element of the received transaction message and the transaction data stored in the one or more additional data elements of the received transaction message;
electronically transmitting, by a transmitting device of the processing server, the received transaction message and the calculated fraud score to the primary financial institution;
receiving, by the receiving device of the processing server, an authorization response from the primary financial institution, wherein the authorization response includes a data element configured to store a response code indicative of denial of the payment transaction;
identifying, by the processing device of the processing server, a secondary financial institution;
modifying, by the processing device of the processing server, the received transaction message by replacing the institution identifier stored in the second data element of the received transaction message with an alternative identifier associated with the identified secondary financial institution; and
electronically transmitting, by the transmitting device of the processing server, the modified transaction message to the acquiring institution.

2. The method of claim 1, wherein modifying the received transaction message further includes modifying a message type indicator indicative of an authorization response and modifying a response code stored in a fourth data element included in the transaction message to indicate approval of the payment transaction.

3. The method of claim 1, wherein the response code stored in the data element of the authorization response indicates denial of the payment transaction related to fraud based on the calculated fraud score.

4. The method of claim 1, wherein the electronic transmission to the primary financial institution is subsequent to identification of the secondary financial institution, and wherein the electronic transmission to the primary financial institution further includes an indication of acceptance of risk by the identified secondary financial institution.

5. The method of claim 4, further comprising:
storing, in the memory of the processing server, an acceptance threshold associated with the primary financial institution, wherein the calculated fraud score exceeds the stored acceptance threshold.

6. The method of claim 1, wherein identification of the secondary financial institution comprises:
electronically transmitting, by the transmitting device of the processing server, at least the transaction amount stored in the second data element of the received transaction message and the calculated fraud score to the secondary financial institution; and
receiving, by the receiving device of the processing server, an indication of acceptance of risk from the secondary financial institution.

7. The method of claim 1, further comprising:
storing, in the memory of the processing server, an acceptance threshold associated with the secondary financial institution, wherein
identification of the secondary financial institution comprises determining, by the processing device of the processing server, that the calculated fraud score does not exceed the acceptance threshold associated with the secondary financial institution.

8. The method of claim 1, wherein the payment transaction is a cross border payment transaction.

9. The method of claim 1, wherein the transaction data includes at least one of: geographic location, transaction time and/or date, merchant category code, merchant identification number, merchant data, product data, loyalty data, reward data, and offer data.

10. The method of claim 1, wherein the one or more standards includes the ISO 8583 standard.

11. A system for processing a declined payment transaction using a secondary financial institution, comprising:
a memory of a processing server configured to store one or more algorithms configured to generate a fraud score for a transaction;
a receiving device of the processing server configured to receive a transaction message for a payment transaction from an acquiring institution, wherein the transaction message is formatted pursuant to one or more standards and includes a plurality of data elements including at least a first data element configured to store a primary account number associated with a transaction account, a second data element configured to store a transaction amount, a third data element configured to store an institution identifier associated with a primary financial institution related to the transaction account associated with the primary account number, and one or more additional data elements configured to store transaction data;
a processing device of the processing server configured to calculate a fraud score for the payment transaction based on application of the one or more algorithms stored in the memory of the processing server to at least the transaction amount stored in the second data element of the received transaction message and the transaction data stored in the one or more additional data elements of the received transaction message; and
a transmitting device of the processing server configured to electronically transmit the received transaction message and the calculated fraud score to the primary financial institution, wherein
the receiving device of the processing server is further configured to receive an authorization response from the primary financial institution, wherein the authorization response includes a data element configured to store a response code indicative of denial of the payment transaction,
the processing device of the processing server is further configured to
identify a secondary financial institution, and
modify the received transaction message by replacing the institution identifier stored in the second data element of the received transaction message with an alternative identifier associated with the identified secondary financial institution, and
the transmitting device of the processing server is further configured to electronically transmit the modified transaction message to the acquiring institution.

12. The system of claim 11, wherein modifying the received transaction message further includes modifying a message type indicator indicative of an authorization response and modifying a response code stored in a fourth data element included in the transaction message to indicate approval of the payment transaction.

13. The system of claim 11, wherein the response code stored in the data element of the authorization response indicates denial of the payment transaction related to fraud based on the calculated fraud score.

14. The system of claim 11, wherein the electronic transmission to the primary financial institution is subsequent to identification of the secondary financial institution, and wherein the electronic transmission to the primary financial institution further includes an indication of acceptance of risk by the identified secondary financial institution.

15. The system of claim 14, wherein the memory of the processing server is further configured to store an acceptance threshold associated with the primary financial institution, wherein the calculated fraud score exceeds the stored acceptance threshold.

16. The system of claim 11, wherein identification of the secondary financial institution comprises:
electronically transmitting, by the transmitting device of the processing server, at least the transaction amount stored in the second data element of the received transaction message and the calculated fraud score to the secondary financial institution; and
receiving, by the receiving device of the processing server, an indication of acceptance of risk from the secondary financial institution.

17. The system of claim 11, wherein
the memory of the processing server is further configured to store an acceptance threshold associated with the secondary financial institution, and
identification of the secondary financial institution comprises determining, by the processing device of the processing server, that the calculated fraud score does not exceed the acceptance threshold associated with the secondary financial institution.

18. The system of claim 11, wherein the payment transaction is a cross border payment transaction.

19. The system of claim 11, wherein the transaction data includes at least one of: geographic location, transaction time and/or date, merchant category code, merchant identification number, merchant data, product data, loyalty data, reward data, and offer data.

20. The system of claim 11, wherein the one or more standards includes the ISO 8583 standard.
